(19) United States
(12) Patent Application Publication
(10) Pub. No.: US 2005/0177784 A1
(43) Pub. Date: Aug. 11, 2005

(54) Creating an html document from a source document

(76) Inventors: Richard L Andrews, New Providence, NJ (US); John M. DeFilippis, Madison, NJ (US); Daniel S. Murphy, Ithaca, NY (US)

Correspondence Address: Richard C Woodbridge;Synnestvedt Lechner & Woodbridge, PO Box 592, Princeton, NJ, 08542-0592, US

(21) Appl. No.: 10/517,753

(22) PCT Filed: Jun. 19, 2003
(86) PCT No.: PCT/US03/19489

Related U.S. Application Data
(60) Provisional application No. 60/390,098, filed on Jun. 19, 2002.

(51) Int. Cl. G06F 17/00

(52) U.S. Cl. 715/513; 715/764

(57) ABSTRACT

A system and method are provided for creating and managing electronic documents, complete with navigational elements, suitable for distribution over a computer network, such as the Internet. The invention includes a method for adding both linear and hierarchical navigation to the electronic document, as well as a method for the generation and management of the appropriate navigational links. The invention also includes a method to apply custom designs to the electronic document through the use of a templating mechanism. The electronic documents produced by the invention are composed of static text and images, do not require any dynamic server process and can be hosted by any Internet Web server software or hosted locally on any computer system or read-only medium, requiring no proprietary hosting technology.

### CROSS REFERENCE TO RELATED APPLICATIONS

This application claims the priority of provisional U.S. application Ser. No. 60/390,098 filed on Jun. 19, 2002 and entitled “System and Method for Adding Navigation to Online Documents” by Richard L. Andrews, John M. DeFilippis and Daniel S. Murphy, the entire contents and substance of which are hereby incorporated in total by reference.

### FIELD OF THE INVENTION

The present invention relates to creating and managing navigation in electronic documents and providing powerful standardization and automation to reduce the cost for delivering user-friendly documents.

### BACKGROUND OF THE INVENTION

Many public companies and governmental organizations are required by law to publish a large volume of documents, including annual reports, proxy statements, and financial reports. Traditionally, distribution of such documents has been done by mailing printed hard copies to the recipients. This process is expensive for the publishing institution and increasingly less desired by many recipients with Internet access.

The widespread use of the Internet makes it an excellent means of distributing information in a cost-effective manner. However, before a document originally intended for off-line (printed) publication can be distributed on the Internet, it must first be converted into a form suitable for on-line (electronic) publication.

Hypertext Markup Language (HTML), which is the standard language used to create Internet documents, is widely used to distribute many types of electronic documents over the Internet. However, the HTML language has several inherent characteristics which render it unsuitable for the distribution of documents that were originally intended for off-line publication. Virtally all paper documents use sequentially numbered pages, in conjunction with a table of contents, to facilitate both linear and hierarchical navigation. HTML does not inherently support any form of page-based navigation. For example, if a 400 page printed document were to be directly converted to HTML, the result would be a single electronic page containing all of the information in the document, with neither a table of contents nor page breaks to facilitate navigation.

An HTML document can be enhanced to include navigational functions. Examples of HTML navigation include: dividing the source document into multiple HTML files and including linear navigation in the HTML files such as “Previous”, “Next”, and “Home” buttons; organization of the document into logical categories for a hierarchical structure, and adding a table of contents with hypertext links to specific sections of the document. However, this enhancement process is labor-intensive, requires personnel skilled in HTML development technologies, takes a lengthy amount of time, and is prone to errors. Each page of the enhanced HTML document requires customization to implement navigational elements.

Moreover, it is likely that the visual appearance of an HTML document that has been enhanced with the simple navigational functions described above will not match the visual appearance of the Internet web site in which the document is published. This mismatch in appearance is a cause for concern among many corporate and institutional publishers of electronic documents, who have expended substantial monies and effort to develop Internet web sites that present a consistent appearance throughout. These inconsistencies can be addressed by adding further enhancements, including customized graphic elements such as icons and tabs, to the basic HTML document. But, as with the basic enhancement process described above, this additional enhancement process takes even more time, requires a more highly skilled level of HTML development personnel, and is prone to an even greater variety of errors.

### SUMMARY OF THE INVENTION

Briefly described, the invention comprises a method and computer system to automatically add navigation to web documents and manage changes to that navigation. The invention removes practically all of the manual labor involved in creation and maintenance of navigation, allows for less skilled users to accomplish tasks normally requiring higher skilled web developers, and removes the potential for errors or “broken links” in documents by automating the creation and management of the navigation.

The invention controls all forms of navigation including linear and hierarchical. The invention can also utilize custom navigation layouts to incorporate specific looks, including matching any existing website design. The document's navigation is directly tied to an outline of the document allowing for fast and easy modifications.

The invention produces online documents that are viewable in any standard browser and do not require any form of plug-in or enhancement to view properly. The online documents can also be hosted by any web server and do not require any non-standard web server-based technology.

### BRIEF DESCRIPTION OF THE DRAWINGS

Various embodiments of the present invention will now be described in detail in conjunction with the annexed drawings, in which:

FIG. 1A illustrates linear navigation and two levels of hierarchical navigation on an enhanced HTML page.

FIG. 1B illustrates a third level of hierarchical navigation on an enhanced HTML page.

FIG. 1C illustrates both “active” and “non-active” hierarchical navigational elements.

FIG. 1D illustrates the use of dropdown navigation.

FIG. 2A illustrates the process of adding navigation to an HTML document.

FIG. 2B illustrates the navigation enhancement process itself.

FIG. 2C illustrates the sub-process of adding all the elements for a specific hierarchical level.

FIG. 2D illustrates an embodiment of the invention for making changes to a navigation-enhanced HTML document.

FIG. 3 illustrates an embodiment of the invention for altering the appearance of a navigation-enhanced HTML document to integrate into an existing website.

FIG. 4 illustrates an embodiment of the invention for adding navigation to an HTML document and altering the appearance to integrate into an existing website.

FIG. 5A illustrates an embodiment of the invention for organizing, managing, and representing hierarchical navigational properties of the document.

FIG. 5B illustrates an embodiment of the invention for organizing, managing, and representing linear navigational properties of the document.

FIG. 5C illustrates an embodiment of the invention for handling document pages which should appear only in linear navigation, or pages in neither hierarchical nor linear navigation, or pages which should not have a template applied.

FIG. 6A illustrates the various elements in an embodiment of the invention's templater.

FIG. 6B illustrates the various substitution codes used by the invention's templater and renderer.

FIG. 7A illustrates an exemplary process used by the invention's renderer to create enhanced HTML pages.

FIG. 7B illustrates an embodiment of the invention wherein the renderer processes substitution codes when creating enhanced HTML pages.

FIG. 7C illustrates an embodiment of the invention wherein the renderer processes hierarchical navigation substitution codes when creating enhanced HTML pages.

FIG. 8 illustrates the previewer component on one embodiment of the invention.

FIG. 9 illustrates the process used in an embodiment of the invention wherein the invention's publisher component follows to send final enhanced HTML pages to a website.

### DETAILED DESCRIPTION

The present invention comprises a method and system for the efficient creation of electronic documents complete with linear and hierarchical navigational elements, and for the automatic and consistent application of visual design elements, including colors, typefaces, layout, and graphic elements such as images or icons, to the documents, thus providing a means for creating electronic documents with sophisticated navigation that can be seamlessly integrated into any existing web site.

The invention is not limited to internet documents as other means of distribution of such electronic documents are contemplated by the invention, including, but not limited to, CD-ROMs and electronic mail. Further, it is envisioned that the invention could be implemented on a particular user's computer—for his individual use. That is, the electronic document is created and stored on the user's computer and not necessarily communicated to another party.

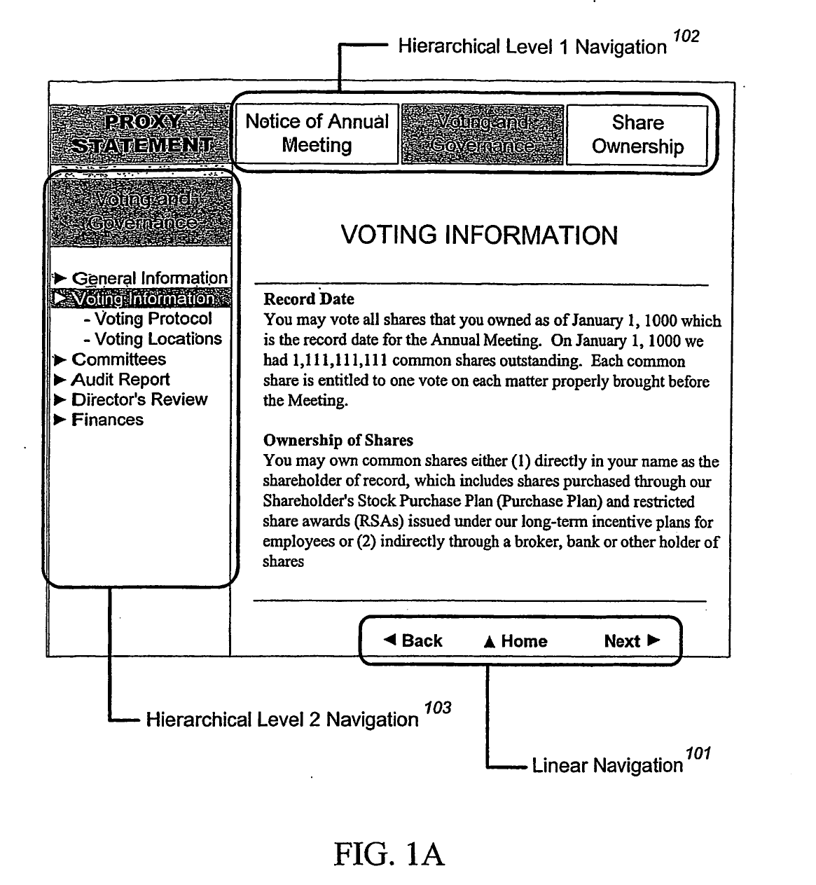

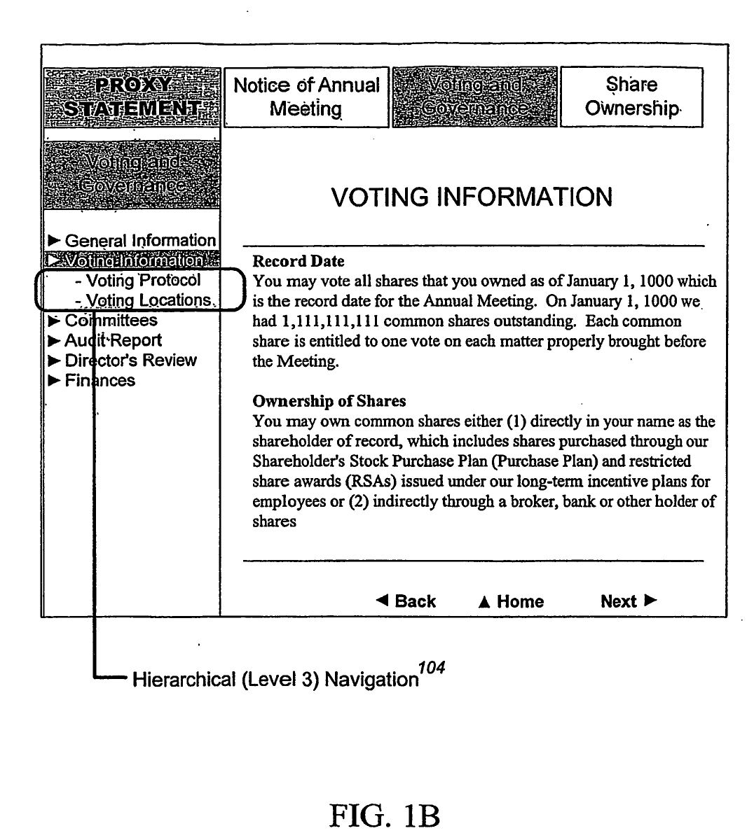

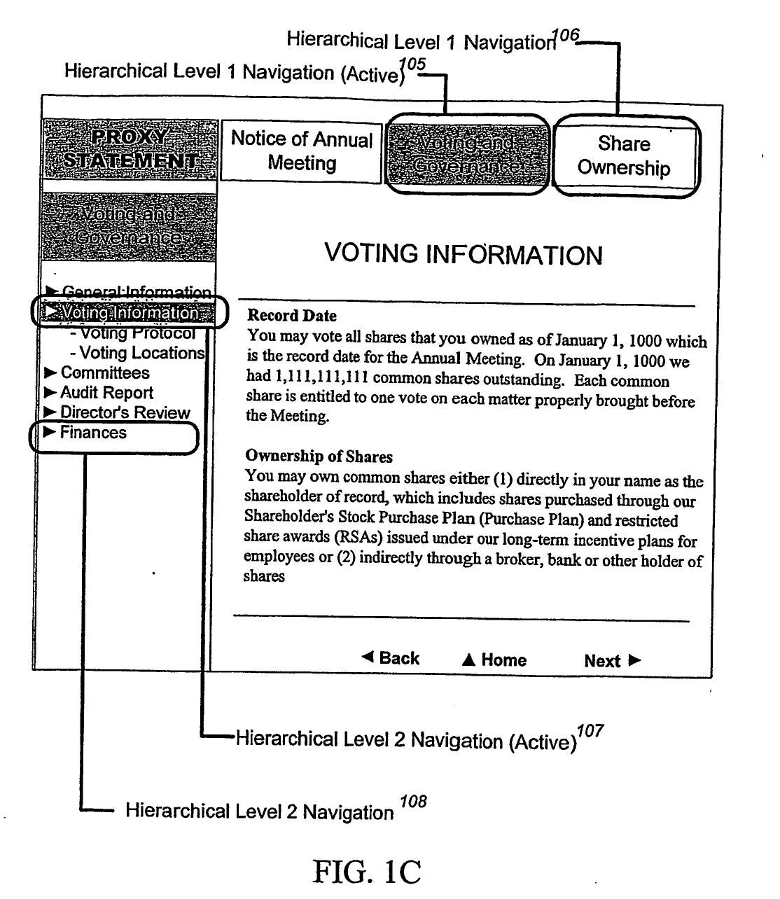

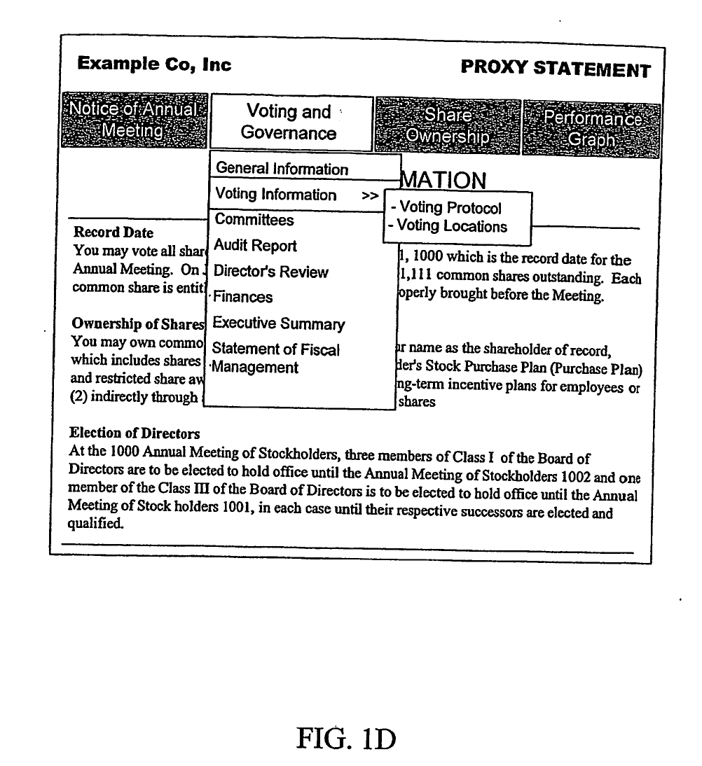

Examples of linear (101) and two levels of hierarchical navigation (103), as contemplated by the invention, are illustrated in FIG. 1A. FIG. 1B illustrates a third level of hierarchical navigation (104). FIG. 1C illustrates how navigational elements will appear differently based upon the reader's context—level 1 navigational elements may be highlighted for the “active” section (105) or non-highlighted for non-active sections (106). Similarly, the active level 2 navigation element (107) may appear different than the non-active level 2 navigational elements (108).

FIG. 1D illustrates an embodiment of the invention in which a dropdown navigation system is employed. In particular, level 1 hierarchical navigational elements are “tabs” and level 2 hierarchical navigational elements appear in a dropdown list when the user hovers over the level 1 element. Level 3 hierarchical navigation elements appear as a pop-up list when the user hovers over their level 2 hierarchical navigation. Level 4 and higher hierarchical levels are possible in dropdown systems as well.

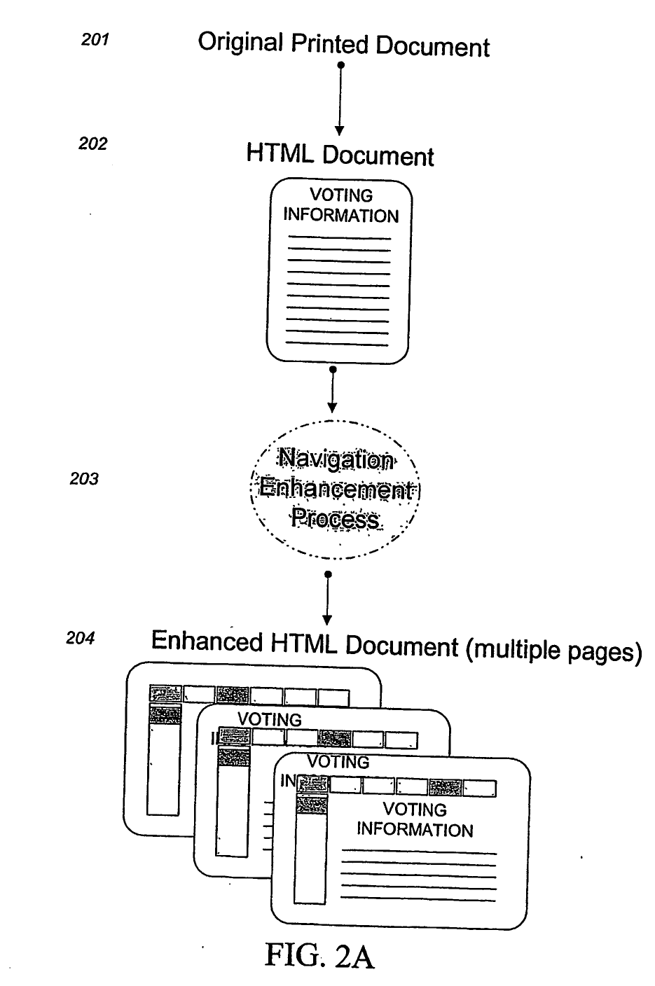

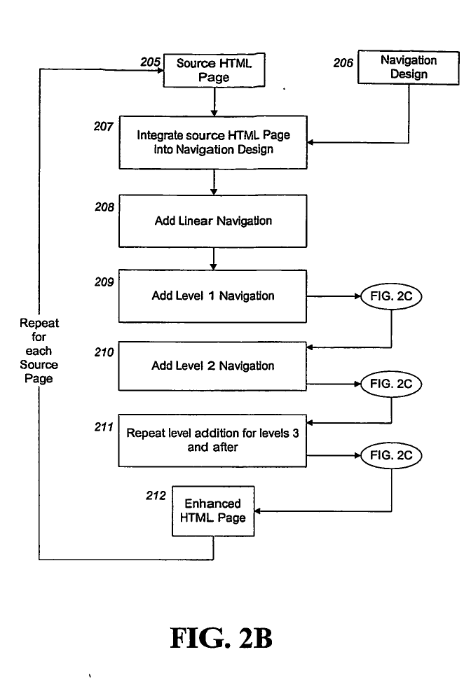

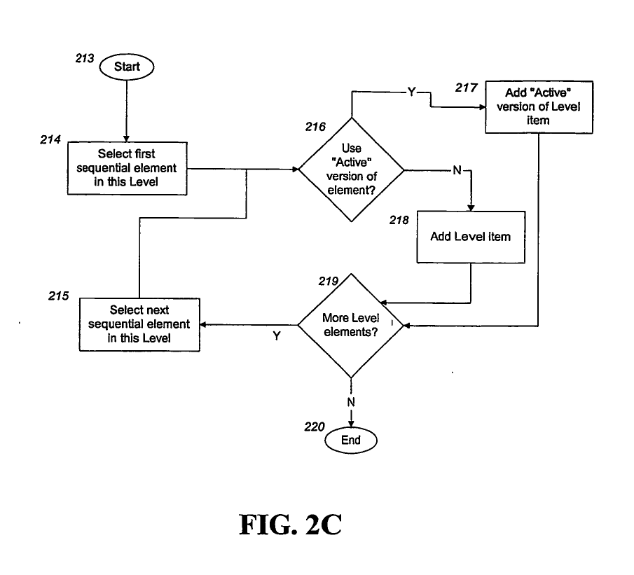

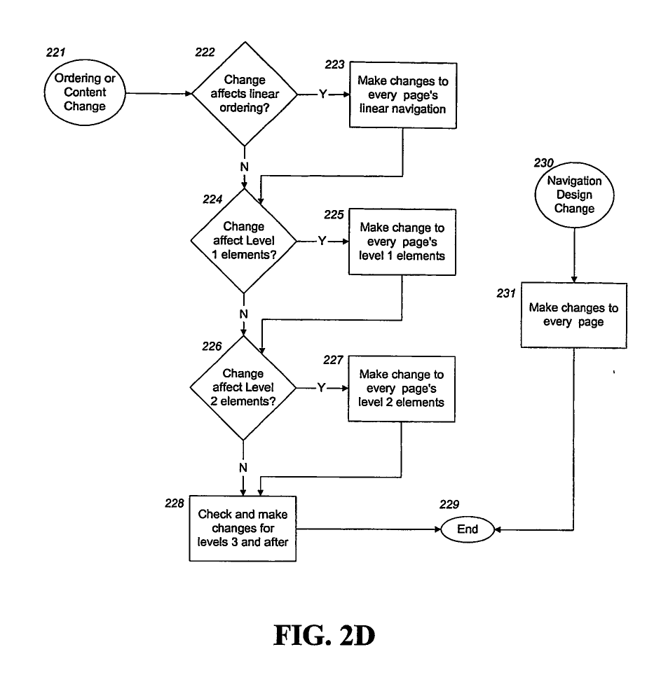

FIG. 2A illustrates the prior art's manual process of adding navigational elements to an HTML document. The source HTML document (202) is split into multiple pages (204), which are then processed as illustrated in FIG. 2B to add navigational elements. When adding any hierarchical navigational element (209, 210, or 211), a sub-process is required to add each element for that level's navigation—and choose the active or non-active version. FIG. 2C illustrates this sub-process. Similar processes are required to build dropdown navigational systems when they are used.

The initial creation of the enhanced HTML document requires significant labor as illustrated in FIGS. 2A, 2B, and 2C. Any changes (221) made after the initial enhancement process also requires significant labor including effort to change every single page in the enhanced HTML document as illustrated in FIG. 2D.

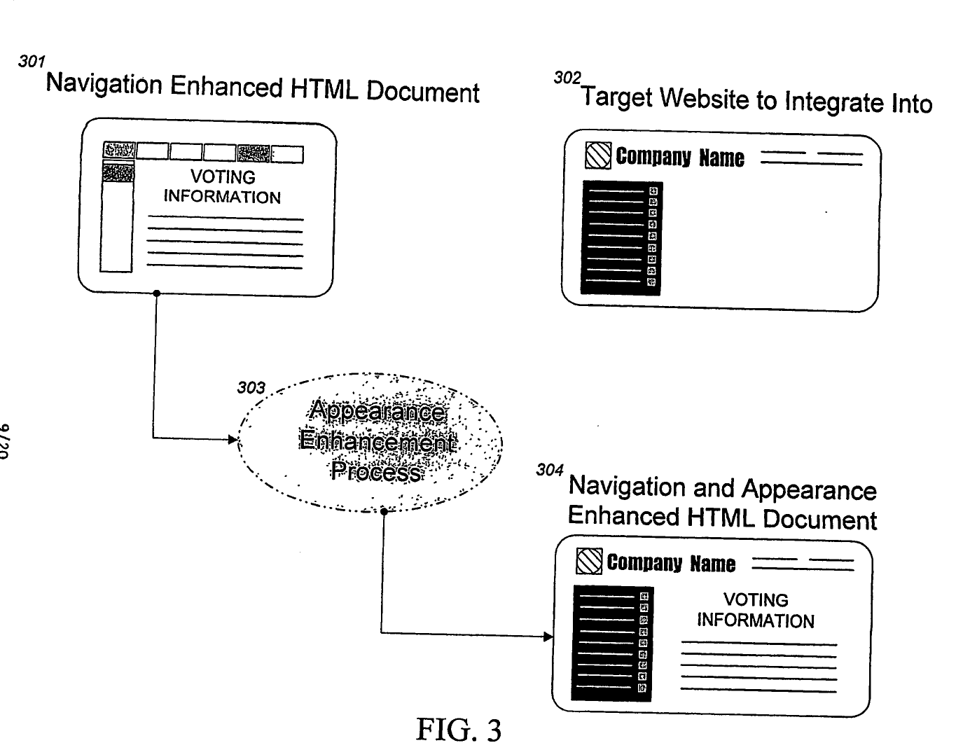

In addition to adding navigation, the appearance of an enhanced HTML page (301) can be manually adjusted to match existing website designs (302) as illustrated in FIG. 3. The invention automates the labor identified in FIGS. 2A, 2B, 2C, 2D, and 3.

In one embodiment, the invention accepts source content in a plurality of forms, including HTML and other electronic formats, such as a word processor document or an Adobe Portable Document Format (PDF) file format. The source content is divided into a series of HTML files, with each file representing one page of the electronic document. In further embodiments of the invention, one or more templates that describe the visual appearance of the pages are defined. Then, the relationships between and among the pages are established through use of an outline mechanism, with both linear and hierarchical navigation instructions being automatically encoded into the page files as the relationships are defined by the user. The templating mechanism uses the previously defined templates to determine the visual appearance of each page of the electronic document, including the appearance and behavior of the icons or other visual symbols used for both the linear and hierarchical navigation. The resulting electronic document, complete with sophisticated navigational elements and a consistent visual appearance, can then be seamlessly integrated into, and published on, an existing Internet web site. The relatively small size of the HTML page files, combined with the comprehensive navigational links, yields an on-line document that is visually consistent with the rest of the web site, and can be quickly downloaded and easily navigated by any user.

One aspect of various embodiments of the invention is that they automate almost all of the steps required to add both linear and hierarchical navigation to the electronic document. Another aspect is that it automates the process of making changes to the content, organization, and visual appearance of the electronic document, thus greatly reducing the labor required to maintain and update the document. Yet another aspect of the invention is that it ties the hierarchical and linear organizations of the document, which are stored in an electronic data file, to a templating Mechanism which controls the generation of navigational links, thus providing an efficient and powerful means to generate navigational links “on the fly” when the electronic document is first created and whenever it is modified. Yet another aspect of the invention is that it includes a templater that defines all aspects of the visual appearance of the electronic document, including the colors, typeface, layout, icons, and other visual characteristics of the document, as well as the graphical elements, such as icons, arrows, or tabs, which are used to represent navigational links on the pages of the document.

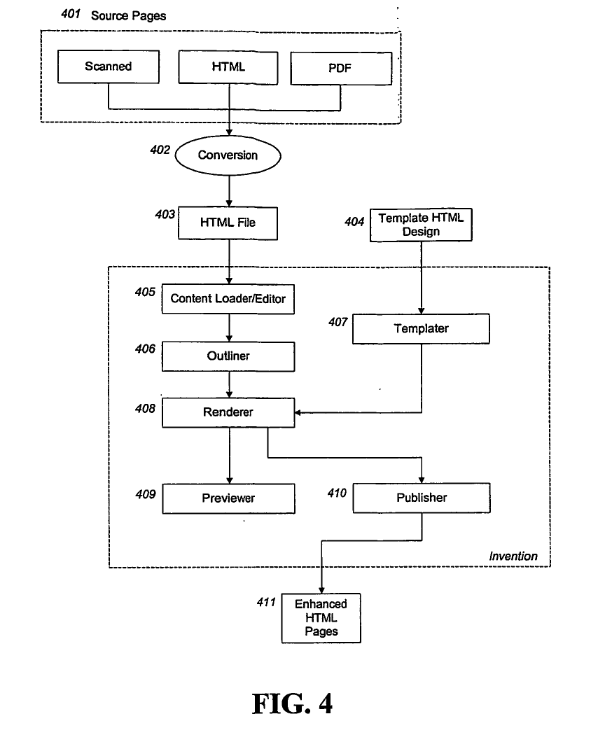

FIG. 4 illustrates the navigation and appearance enhancement process of an embodiment of the invention. The electronic document creation process begins with a source document (401). The invention accepts source documents existing in a plurality of forms, including a printed hard copy, or in electronic form such as a Microsoft Word document or an Adobe Portable Document File (PDF) document.

The source document is then converted (402) into a series of HTML files (403), with each file representing one page of the document. In the case of a paper document, this is accomplished by scanning the printed pages. In the case of an electronic document, the HTML files are created by a software utility. The source page files representing the source document are then loaded into the invention's Content Loader/Editor component (405), which creates a page node for each file and automatically assigns sequential ordering, thus creating a linear navigation format for the entire document.

Once the page files have been imported into the invention and assigned the sequential ordering, the user can then modify the relationships between the page nodes to define hierarchical relationships with any number of levels. Page nodes can have a parent node, child nodes, and sibling nodes which fully define the hierarchical relationships. In one embodiment of the invention, this is accomplished by using the outliner component (406). The outliner incorporates a “drag and drop” computer interface which allows the user to quickly and efficiently define, arrange and re-arrange the relationships between and among the page nodes. For example, the user can easily “promote” or “demote” the position of a page node in the document's hierarchy by selecting the appropriate icon and moving it with the mouse. The hierarchical relationships, along with the previously created linear relationships, are stored in a text file that has been formatted to represent data (for example, an Extensible Markup Language “XML” file). Alternatively, if desired, these data can be stored in a relational database management system (RDMS), which are well-known in the prior art.

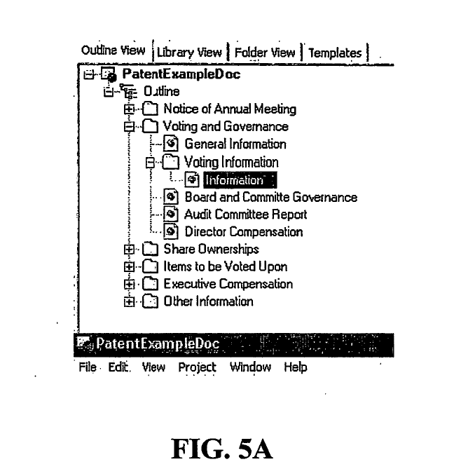

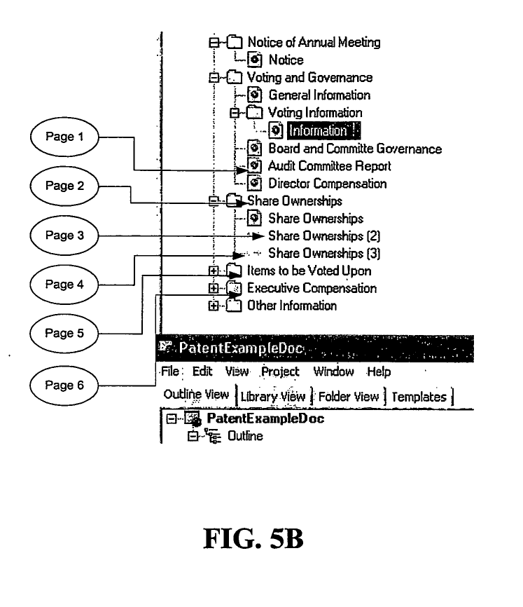

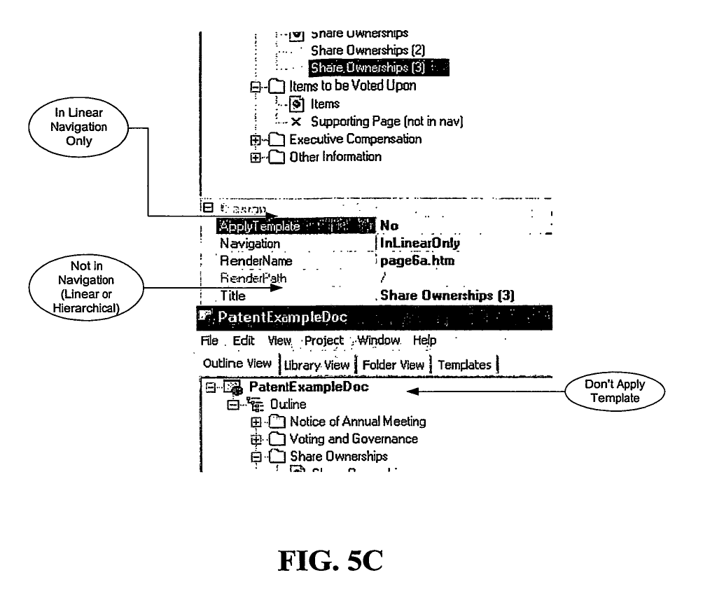

FIG. 5A illustrates the outliner's ability to represent hierarchical navigational information for the document. The outliner thus organizes a document into logical relationships which are then used to control all navigation and enable automation of enhanced HTML page creation at speeds and costs which cannot be matched by manual methods. The outline relationships are also used to control dropdown menus, another difficult labor-intensive task prone to errors. Pages which have more than one hierarchical element can be handled by splitting the page into two separate pages, each with their own hierarchical element, or by having two hierarchical elements refer to the same page.

FIG. 5B illustrates the outliner's ability to represent linear navigational information. FIG. 5C illustrates the outliner's ability to have special properties to handle pages that should appear only in linear navigation (and not in hierarchical navigation), pages which should not appear in either linear or hierarchical navigation, or pages that should not be processed using the templater (discussed below).

Returning to FIG. 4, an additional feature of the depicted embodiment, used as a part of the document creation process, is the templater (407), which permits the user to describe and specify various characteristics of the visual appearance of the document. The templater can be used to describe both the overall “look” of the document—including colors, typefaces, layout, and other visual elements—as well as the appearance and behavior of the icons, tabs, buttons, menus, arrows, or other visual symbols or objects which are used to facilitate both the linear and hierarchical navigation within the document. The templates that have been defined using the templater are stored in a text file that has been formatted to represent data (for example, an Extensible Markup Language “XML” file.) Alternatively, these data can be stored in a relational database management system (RDMS) if desired.

In an embodiment of the invention, the visual appearance of the electronic document, including colors, fonts, graphic images, layout, and so forth, are controlled by the invention's template mechanism, which applies the templates that have been created using the templater to each page of the document. The template mechanism allows the user to control the overall “look and feel” of the electronic document in a simple and efficient manner. The template mechanism is directly tied to the invention's outliner in a way such that any action made by the user in the outliner resulting in a change to the organization of the document automatically causes the appropriate changes to be made to the navigational links of all pages that are affected by the change.

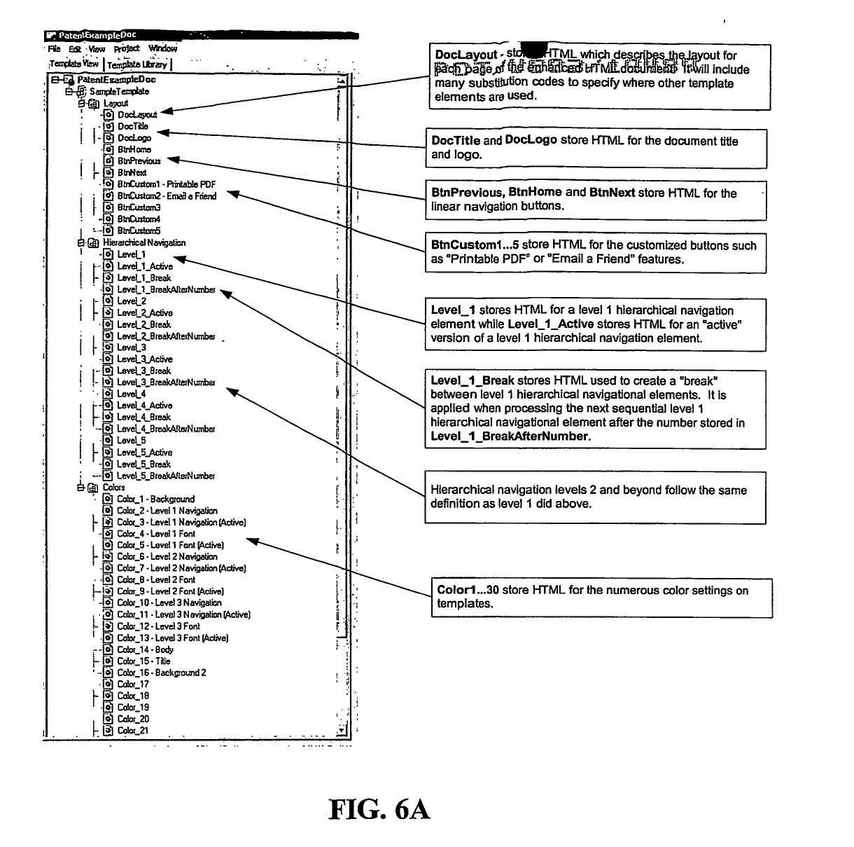

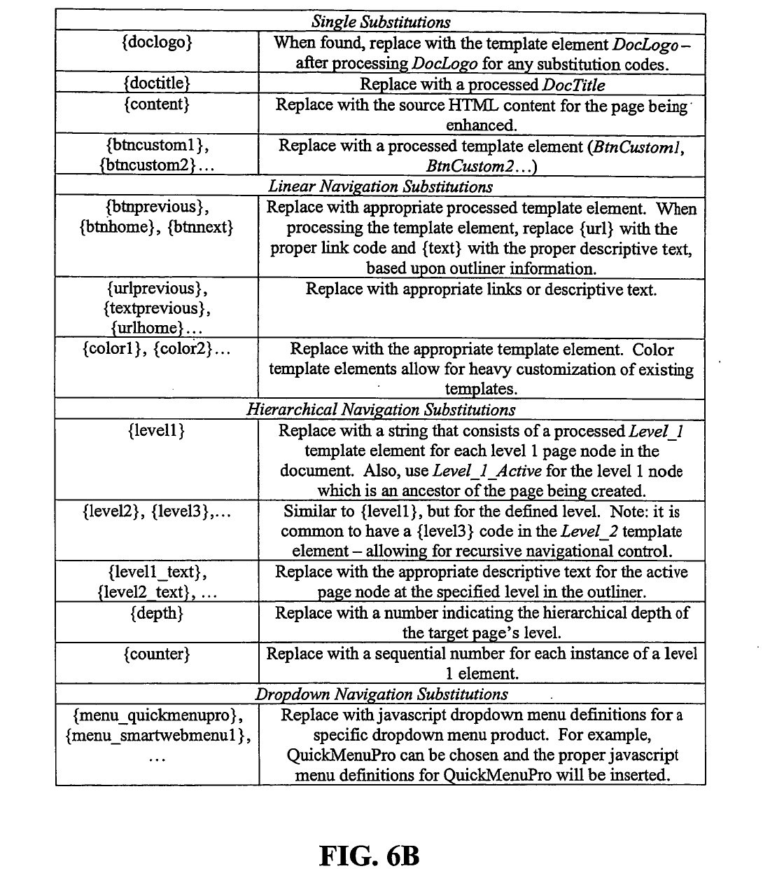

The templater uses a series of template elements and template substitution codes to define how the final enhanced HTML pages are created. Each template element stores HTML code that is used in specific ways to create the final enhanced HTML document. FIG. 6A illustrates the various template elements and their specific functions.

The templater's substitution system is a series of codes that is used to build the enhanced HTML document as illustrated in FIG. 6B. These codes are placed into various template elements to control how the final enhanced HTML document is created. For example, the DocLayout template element will normally have {doctitle} to indicate where the document's title should be placed, {doclogo} to indicate where the logo should be placed, and many other substitution codes.

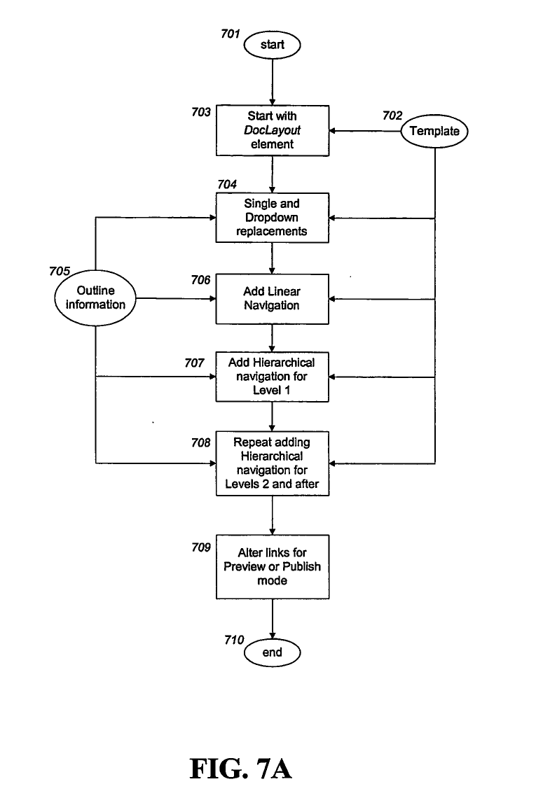

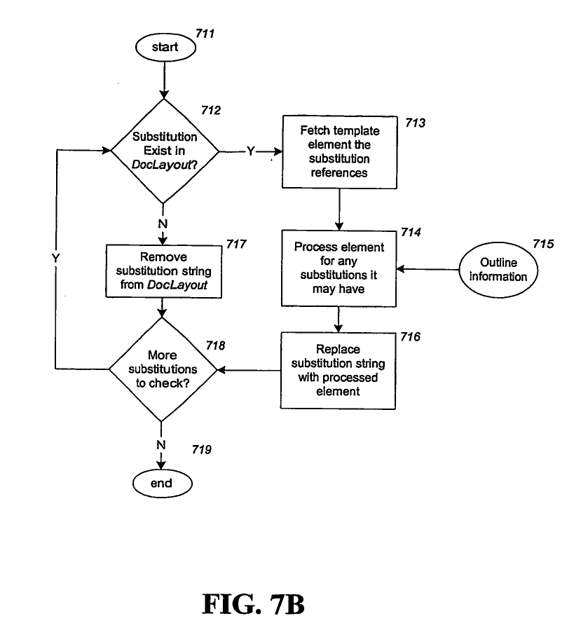

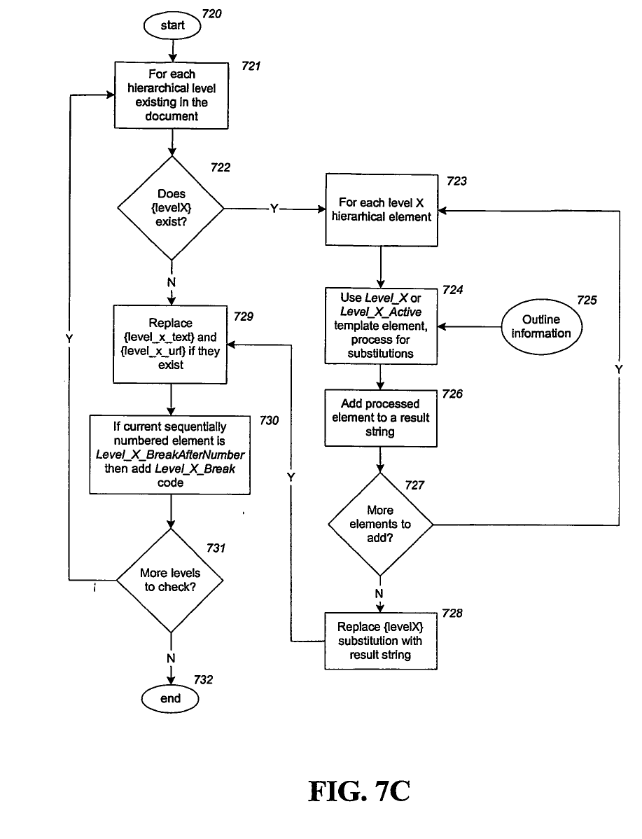

As depicted in FIG. 4, the invention has a renderer component (408), which creates the final enhanced HTML pages using the source content, outliner information, and template information. FIG. 7A illustrates the renderer's process in one embodiment of the invention. Each page to be rendered starts the process by using the DocLayout template element (703) and processing a series of substitutions.

The document layout element is then processed for single and dropdown substitutions (704) such as {content}, {doclogo}, {doctitle}, {btncustoml }, {menu_quickmenupro}, etc. Then linear navigation is added (706) using substitutions such as {btnprevious}, {btnnext}, {btnhome} etc.

For example, if {btnprevious} exists in the DocLayout template element, the renderer will fetch the template element BtnPrevious, process that element for any substitutions it may have, and then insert the result into DocLayout, replacing the {btnprevious} text. FIG. 7B illustrates this substitution process. When processing elements for substitutions, the renderer will utilize information from the outliner (715) to accurately add text and links to items such as linear navigation and dropdown navigation.

The renderer processes hierarchical navigation in a different manner than other substitutions. In the embodiment depicted in FIG. 7C, when a hierarchical substitution code is encountered (722), such as {level1}, the renderer will build a string (726) to be inserted which has code for each of the document's page nodes that are in that level. For example, when {level1} exists, the renderer will add a Level_{—}1 template element for each of the level 1 hierarchical page nodes in the outliner. If a specific level 1 page is an ancestor of the page being created, the Level_{—}1_Active template element will be used instead of the normal Level_{—}1 element. This process automates the labor identified in FIG. 2C. The template element substitution step (724) utilizes information from the outliner and may recursively call the hierarchical substitution code process if hierarchical navigation substitution codes exist in that element.

Referencing FIG. 7A, a similar process is then executed for all hierarchical navigational levels (707 and 708). Finally, all references to graphics and links are controlled to work properly (709) in preview or publish versions of the final document.

In additional embodiments of the invention it is contemplated that the templater and renderer components include the ability to load any custom design, and can be used to generate pages that seamlessly integrate into any existing website design. The invention can thus be used to manage content within an existing website and to integrate newly-created electronic content with other products and processes.

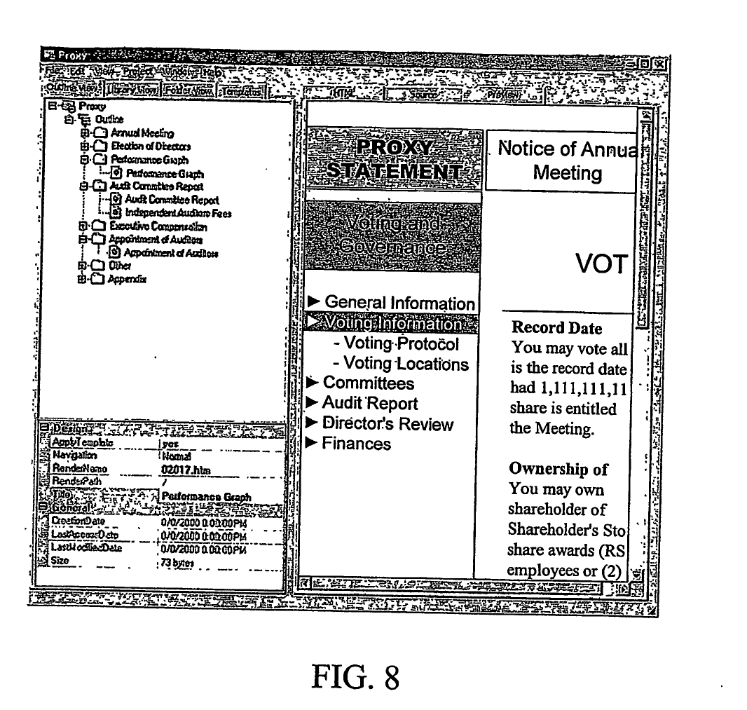

Further embodiments of the invention also include a previewer component as illustrated in FIG. 8, which allows the user to preview how the electronic document will appear when it is distributed over the Internet and viewed in a web browser. This previewer component provides the user with an efficient method for ensuring that the electronic document is consistent with the appearance of the website where it will be published.

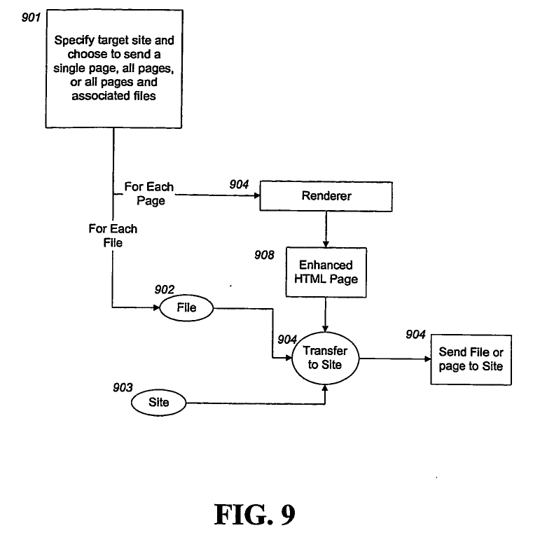

Still further embodiments of the invention also include a publisher component (410), which allows the user to send the HTML files representing the electronic document to a web server. FIG. 9 illustrates the publisher's process for publishing final enhanced HTML documents.

Thus, the above described components of the invention, including the outliner, templater, renderer, previewer, and publisher, comprise an entire system and method for creating electronic documents, complete with both hierarchical and linear navigation that can be seamlessly integrated into existing Internet web sites. Moreover, the invention dramatically reduces the labor cost for enhancing HTML documents with navigation and appearance features as illustrated in FIG. 2B, 2C, and 3. In addition, the invention also dramatically reduces the labor cost for making changes to documents which have already been enhanced, as illustrated in FIG. 2D.

It will be understood that the forgoing description of the invention is by way of example only, and variations will be evident to those skilled in the art without departing from the scope of the invention, which is as set out in the appended claims.

1. A system for creating a static electronic document from a source document having a source content, said source content comprising source pages, said electronic document providing linear and hierarchical navigational elements, said system comprising:
a computer;
a means for inputting said source document into said computer in the form of a series of HTML files, each file corresponding to one of said source pages;
a means for creating a page node for each file and assigning a sequential ordering to each said page node;
an outliner means for assigning hierarchical relationships between said page nodes, whereby at least two hierarchical levels are established;
a templater means for defining a template, said template specifying characteristics of the visual appearance of the electronic document;
a means for storing said template; and,
a rendering means for creating final static HTML pages to be displayed, said rendering means employing said template, said hierarchical relationships and said source content.

2. The system of claim 1 wherein said outliner means comprises a drag and drop computer interface means.

3. The system of claim 1 wherein said templater means utilizes a series of template elements and template substitution codes.

4. The system of claim 3 wherein said rendering means comprises performing a series of substitutions in accordance with said template substitution codes.

5. The system of claim 4 wherein said rendering means further comprises building a string to be inserted for each appropriate hierarchical level whenever a hierarchical substitution code is encountered.

6. The system of claim 1 further comprising a publisher means for distributing over the Internet said final HTML pages.

7. The system of claim 6 further comprising a previewer means for viewing at the computer how the final HTML pages will appear to an Internet reader.

8. The system of claim 1 wherein said source content is in at least one of a plurality of formats, said plurality of formats selected from the group consisting of printed pages, HTML, Adobe Portable Document Format (PDF), Graphics Interchange Format (GIF), Joint Photographic Experts (JPEG), Microsoft Word, and any other electronic format recognizable by the computer.

9. A method for creating a static electronic document from a source document having a source content, said source content comprising source pages, said electronic document providing linear and hierarchical navigational elements, said method comprising the steps of:
inputting said source document into a computer in the form of a series of HTML files, each file corresponding to one of said source pages;
creating a page node for each file and assigning a sequential ordering to each said page node;
assigning hierarchical relationships between said page nodes, whereby at least two hierarchical levels are established;
defining a template, said template specifying characteristics of the visual appearance of the electronic document;
storing said template; and,
rendering final, static HTML pages to be displayed, said rendering employing said template, said hierarchical relationships and said source content.

10. The method of claim 9 wherein said step of assigning hierarchical relationships comprises using a drag and drop computer interface means.

11. The method of claim 9 wherein said step of defining a template utilizes a series of template elements and template substitution codes.

12. The method of claim 11 wherein said rendering step comprises performing a series of substitutions in accordance with said template substitution codes.

13. The method of claim 12 wherein said rendering step further comprises building a string to be inserted for each appropriate hierarchical level whenever a hierarchical substitution code is encountered.

14. The method of claim 9 further comprising a publishing step for distributing over the Internet said final HTML pages.

15. The method of claim 14 further comprising a step of previewing at the computer how the final HTML pages will appear to an Internet reader.

16. The method of claim 9 wherein said source content is in at least one of a plurality of formats, said plurality of formats selected from the group consisting of printed pages, HTML, Adobe Portable Document Format (PDF), Graphics Interchange Format (GIF), Joint Photographic Experts (JPEG), Microsoft Word, and any other electronic format recognizable by the computer.

17. A computer program product recorded on computer readable medium and containing indicia of instructions for a computer to perform a method of creating a static electronic document from a source document having a source content, said source content comprising source pages, said electronic document providing linear and hierarchical navigational elements, said method comprising the steps of:
inputting said source document into a computer in the form of a series of HTML files, each file corresponding to one of said source pages;
creating a page node for each file and assigning a sequential ordering to each said page node;
assigning hierarchical relationships between said page nodes, whereby at least two hierarchical levels are established;
defining a template, said template specifying characteristics of the visual appearance of the electronic document;
storing said template; and,
rendering final, static HTML pages to be displayed, said rendering employing said template, said hierarchical relationships and said source content.

18. The computer program product of claim 17 wherein said step of assigning hierarchical relationships comprises using a drag and drop computer interface means.

19. The computer program product of claim 17 wherein said step of defining a template utilizes a series of template elements and template substitution codes.

20. The computer program product of claim 19 wherein said rendering step comprises performing a series of substitutions in accordance with said template substitution codes.

21. The computer program product of claim 20 wherein said rendering step further comprises building a string to be inserted for each appropriate hierarchical level whenever a hierarchical substitution code is encountered.

22. The computer program product of claim 17 wherein said method further comprises a publishing step for distributing over the Internet said final HTML pages.

23. The computer program product of claim 22 wherein said method further comprises a step of previewing at the computer how the final HTML pages will appear to an Internet reader.

24. The computer program product of claim 17 wherein said source content is in at least one of a plurality of formats, said plurality of formats selected from the group consisting of printed pages, HTML, Adobe Portable Document Format (PDF), Graphics Interchange Format (GIF), Joint Photographic Experts (JPEG), Microsoft Word, and any other electronic format recognizable by the computer.
